(19) United States
(12) Patent Application Publication
(10) Pub. No.: US 2025/0162360 A1
(43) Pub. Date: May 22, 2025

(54) TOW ROPE AND WINCH HAVING SAME

(71) Applicant: T-MAX (HANGZHOU) TECHNOLOGY CO., LTD., Hangzhou (CN)

(72) Inventors: Hangfei YU, Hangzhou (CN); Guokang YE, Hangzhou (CN)

(21) Appl. No.: 18/775,958

(22) Filed: Jul. 17, 2024

(30) Foreign Application Priority Data
Nov. 17, 2023 (CN) 202311538972.1
Nov. 17, 2023 (CN) 202323117320.9

(51) Int. Cl. B60D 1/18; B63B 21/16; B63B 21/20; B66D 1/28; D07B 1/18

(52) U.S. Cl. CPC B60D 1/185; B60D 1/18; B63B 21/16; B63B 21/20; B66D 1/28; D07B 1/185; D07B 2501/20

(57) ABSTRACT

Disclosed is a tow rope and a winch with the tow rope. In some embodiments in accordance with the present technology, a tow rope includes a rope body and a first diamond knot. The rope body has a first end and a second end, and the first end of the rope body is provided with a first loop. The first diamond knot is coupled to the rope body, and a coupling position of the first diamond knot and the rope body is adjacent to the first loop. The first diamond knot and the first loop are fastenable to form a first eye, and the first diamond knot is detachable from the first loop.

### CROSS-REFERENCE TO RELATED APPLICATIONS

This patent document claims priority to and benefits of Chinese Application No. 202311538972.1, filed on Nov. 17, 2023, and Chinese Application No. 202323117320.9, filed on Nov. 17, 2023. The entire contents of the aforementioned patent documents are incorporated by reference for all purposes.

### TECHNICAL FIELD

The present disclosure pertains to the field of rope, and more particularly, the present disclosure relates to a tow rope and a winch having the tow rope.

### BACKGROUND

Tow ropes are widely used for towing and rescuing of vehicles or watercrafts.

### SUMMARY

A tow rope according to some embodiments of the present technology includes a rope body and a first diamond knot. The rope body has a first end and a second end, and the first end of the rope body is provided with a first loop. The first diamond knot is coupled to the rope body, and a coupling position of the first diamond knot and the rope body is adjacent to the first loop. The first diamond knot and the first loop are fastenable to form a first eye, and the first diamond knot is detachable from the first loop.

A winch according to some embodiments of the present technology includes a reel and a tow rope wound around the reel, and the tow rope may be a tow rope in the above embodiments.

### BRIEF DESCRIPTION OF THE DRAWINGS

FIG. 1 shows a partial schematic view of a tow rope according to some embodiments of the present technology, with a first diamond knot detached from a first loop.

FIG. 2 shows a schematic view of the tow rope illustrated in FIG. 1, with a first diamond knot and a first loop fastened.

FIG. 3 shows a schematic view of a tow rope according to another embodiment of the present technology, with a first diamond knot detached from a first loop and a second diamond knot detached from a second loop.

FIG. 4 shows a schematic view of the tow rope illustrated in FIG, 3, with a first diamond knot and a first loop fastened and a second diamond knot and a second loop fastened.

FIG. 5 shows a plan schematic view of the tow rope illustrated in FIG. 3.

FIGS. 6A-6C shows a partial schematic view of a first end (second end) of a tow rope according to some embodiments of the present technology, with a first (second) loop gradually becoming smaller.

FIG. 7 shows a schematic view of a first (second) limiting sleeve of a tow rope according to some embodiments of the present technology.

FIG. 8 shows another schematic view of the first (second) limiting sleeve illustrated in FIG. 7.

FIG. 9 shows yet another schematic view of the first (second) limiting sleeve illustrated in FIG. 7.

FIG. 10 shows still another schematic view of the first (second) limiting sleeve illustrated in FIG. 7.

FIG. 11 shows a plan schematic view of the first (second) limiting sleeve illustrated in FIG. 7.

### DETAILED DESCRIPTION

Embodiments of the present technology are described in detail below, examples of which are illustrated in the accompanying drawings. The following embodiments described with reference to the accompanying drawing are illustrative. It should be understood that the embodiments described are intended to explain the present disclosure, but not to limit the present disclosure.

In the related art, two ends of a tow rope are provided with a loop, respectively. When in use, the loop at one end of the tow rope may be sleeved on a tow hook of a vehicle, and the loop at the other end of the tow rope may be sleeved on a tow hook of another vehicle. However, such a tow rope suffers problems of inconvenience in use. For example, when the vehicle uses the tow rope to save itself, the loop at one end of the tow rope is sleeved on the tow hook of the vehicle, the other end of the tow rope needs to be coupled to a tree or other fixed coupling objects such as a fixed pile; and because the loop at the other end of the tow rope cannot be directly sleeved on the tree or the fixed pile, it is not convenient to use. The related art also proposes a tow rope, one end of the tow rope forms a loop, the other end of the tow rope forms a rope knot (generally referred to as a diamond knot). When in use, the rope knot at one end of the tow rope is fastened with the loop on the other end of the tow rope, thus the tow rope forms a ring shape as a whole. However, due to the need to couple one end of the tow rope with the other end of the tow rope, especially when the tow rope is long, there are problems of inconvenient coupling between the loop and the rope knot, as well as inconvenient coupling between the tow rope and other objects. In addition, as one end of the tow rope is coupled to the other end, a length of the tow rope is reduced, which reduces the convenience of use. Moreover, since the tow rope forms a ring as a whole, there are further problems of inconvenience in use.

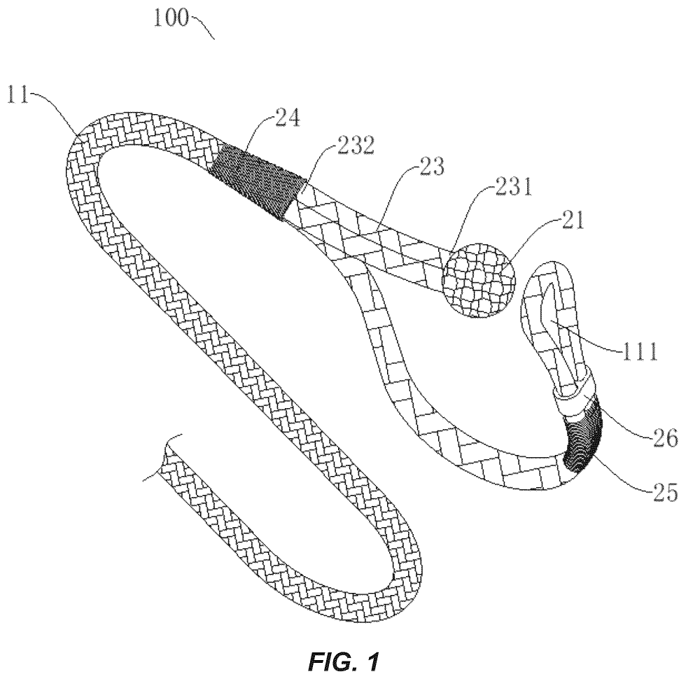

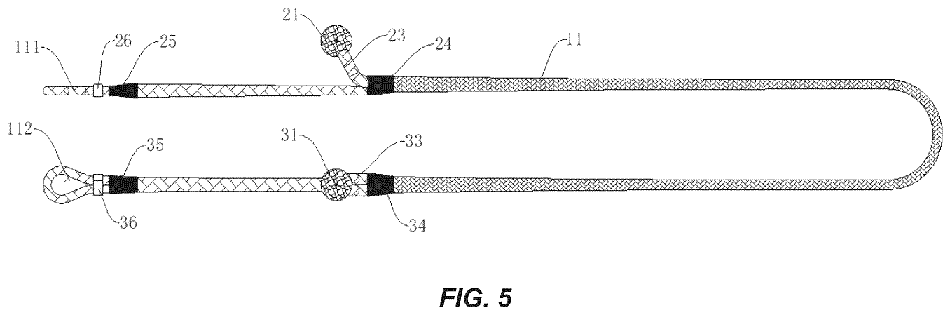

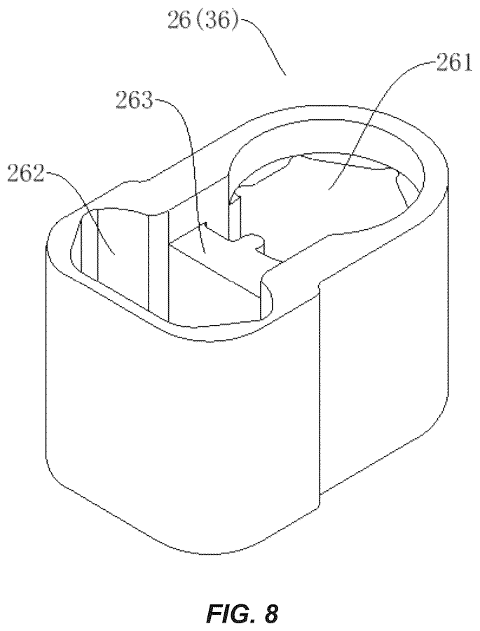

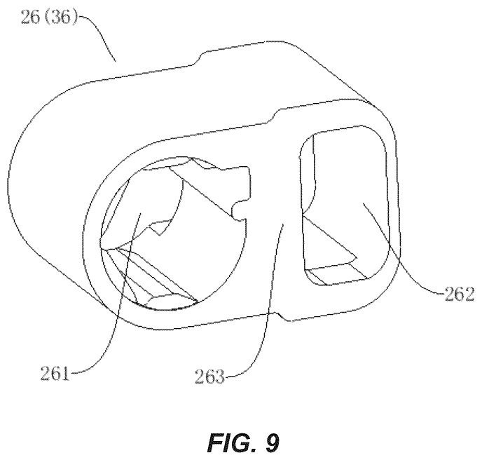

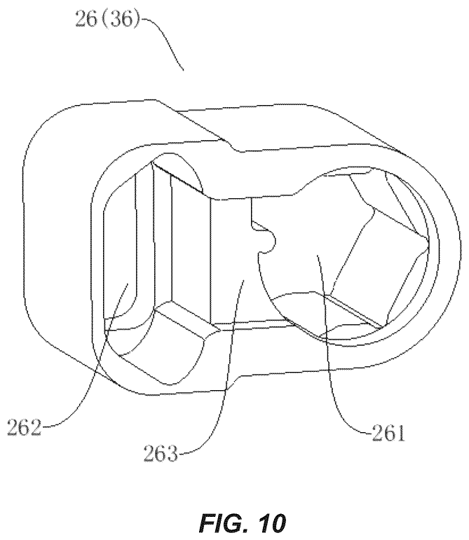

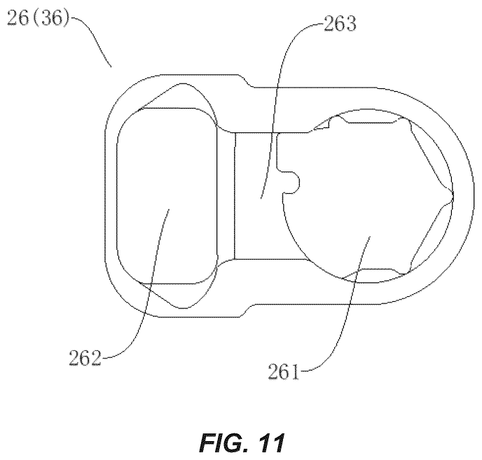

The disclosed tow rope in accordance with the present technology alleviates such problems and provides a robust, convenient, and versatile tow rope, e.g., for a variety of applications and devices, including a winch for a vehicle. A tow rope 100 according to embodiments of the present technology is described below with reference to FIGS. 1 to 11.

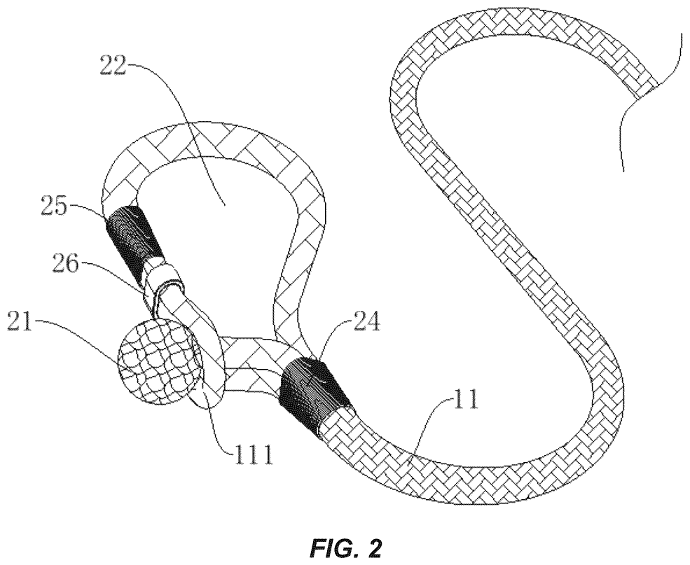

As illustrated in FIG. 1, the tow rope 100 includes a rope body 11 and a first diamond knot 21. The rope body 11 has a first end and a second end in its length direction, and in FIG. 1, the second end of the rope body 11 is not illustrated. The first end of the rope body 11 is provided with a first loop 111, the first diamond knot 21 is coupled to the rope body 11, and a coupling position of the first diamond knot 21 and the rope body 11 is adjacent to the first loop 111. The first diamond knot 21 and the first loop 111 are fastenable to form a first eye 22, as illustrated in FIG. 2; and the first diamond knot 21 is detachable from the first loop 111, as illustrated in FIG. 1.

In some embodiments where the first diamond knot 21 is coupled to the rope body 11, this can include the first diamond knot 11 being directly arranged on the rope body 11, and the first diamond knot 11 being coupled to the rope body 11 through a certain length of coupling rope body. In embodiments illustrated in FIGS. 1 and 2, the first diamond knot 11 is coupled to the rope body 11 through a first coupling rope body 23.

In some embodiments where the coupling position of the first diamond knot 21 and the rope body 11 is adjacent to the first loop 111, this means that in the case that the first diamond knot 21 is directly arranged on the rope body 11, a distance between the first diamond knot 21 and the first end of the rope body 11 is less than a distance between the first diamond knot 21 and the second end of the rope body 11; and in the case that the first diamond knot 21 is coupled to the rope body 11 through the first coupling rope body 23, a distance between the coupling position of the first coupling rope body 23 and the rope body 11 and the first end of the rope body 11 is less than a distance between the coupling position and the second end of the rope body 11. In some embodiments, a length of the first coupling rope body 23 is less than a distance between the coupling position and the first loop 111. For example, the distance between the coupling position and the first loop 111 is 200-400 mm, and the length of the first coupling rope body 23 is 50-150 mm. There is no special limit on a length of the rope body 11, and for example, it may be 3 meters-50 meters.

As illustrated in FIG. 2, the first diamond knot 21 and the first loop 111 being fastened means that the first diamond knot 21 passes through the first loop 111 and is stuck, to form an annular first eye 22 at the first end of the rope body 11, and the first eye 22 may be sleeved on a coupling object. As illustrated in FIG. 1, the first diamond knot 21 being detached from the first loop 111 means that the first diamond knot 21 comes out of the first loop 111 and is detached, at this time, the first eye 22 is not formed at the first end of the rope body 11.

In some examples of the tow rope according to embodiments of the present technology, the first loop is arranged at the first end of the rope body, the first diamond knot is arranged adjacent to the first end of the rope body, the first diamond knot and the first loop are fastenable or detachable, and the first eye is formed when the first diamond knot is fastened to the first loop. For example, when in use, the first diamond knot may be fastened around a coupling object such as a fixed pile, to form the first eye surrounding a fixed coupling object, so that it is convenient to couple the first end of the rope body to the coupling object. After use, for example, the first diamond knot is detached from the first loop, so that the first end of the rope body is detached from the coupling object. Therefore, the coupling and decoupling of the tow rope and the coupling object are convenient and quick. Furthermore, because the first diamond knot is adjacent to the first loop, the convenience of fastening and detachment operation between them is not affected by the length of the rope body, and the length of the tow rope will not be shortened by the formation of the first eye. Therefore, the use convenience of the tow rope in accordance with embodiments of the present technology is greatly improved compared with the tow rope in the related art.

It should be noted that, when in use, if the tow object has a ready-made tow hook or shackle (such as a vehicle), the first loop may be directly sleeved on the tow hook or the shackle, that is, the tow object is directly hung and coupled by the first loop, and if the tow object body does not have a coupling point that may be directly hung (such as a tree or the fixed pile), the first eye may be used to couple its frame. Therefore, the tow rope according to embodiments of the present technology has multi-purpose performance and has strong universality and convenience of use.

The tow rope according to embodiments of the present technology may also become a safe and high-strength multi-functional trailer extension integral rope.

In some examples, the rope body 11 is a fiber rope. The rope body 11 includes an ultra-high molecular weight polyethylene fiber rope core, an ultra-high molecular weight polyethylene tightly woven sheath covering the rope core and a polyurethane coating coated outside the sheath, which has advantages of wear resistance, light weight, chemical corrosion resistance and ultraviolet resistance.

In some embodiments, the first loop 111 is formed by splicing the first end of the rope body 11. “Splicing” refers to coupling two or more segments of the rope body by weaving. As an example, as illustrated in FIGS. 1 and 2, the first end of the rope body 11 is coupled to the rope body 11 by splicing to form an annular first loop 111. The first loop 111 is formed at the first end of the rope body 11 by means of splicing, that is, a rope body segment that forms the first loop 111 is integrally formed with other parts of the rope body 11, thus the integrity of the tow rope 100 is stronger, at the same time, the splicing point has strong coupling strength, and the coupling is not easy to be broken, thus the tow rope 100 has stronger reliability.

In some embodiments, the first diamond knot 21 is directly coupled to the rope body 11, that is, the rope body 11 is provided with a first diamond knot 21 directly at a position adjacent to its first end, and the first diamond knot 21 lies against the rope body 11.

In some embodiments, the first diamond knot 21 is spliced to the rope body 11, that is, a rope thread that forms the first diamond knot 21 and a rope thread that forms the rope body 11 are coupled by weaving at a position adjacent to the first loop 111. In other words, the rope body 11 is bifurcated at the position adjacent to the first loop 111, a split rope strand is knotted to form the first diamond knot 21, and the first diamond knot 21 is spliced to the rope body 11, so that the first diamond knot 21 is integrally formed with the rope body 11 and the coupling between them is stronger and more reliable.

In other embodiments, as illustrated in FIGS. 1 and 2, the tow rope 100 may further include a first coupling rope body 23, the first coupling rope body 23 has a first free end 231 and a first coupling end 232, the first diamond knot 21 is arranged at the first free end 231, and the first coupling end 232 is coupled to the rope body 11. In other words, the first diamond knot 21 is coupled to the rope body 11 through the first coupling rope body 23, and the coupling position of the first coupling rope body 23 and the rope body 11 is adjacent to the first loop 111.

By using the first coupling rope body 23, for example, it may be more convenient to arrange the first diamond knot 21 and to fasten and detach the first diamond knot 21 from the first loop 111. When the first diamond knot 21 and the first loop 111 are fastened and tightened, a position where the first loop 111 abuts against is a junction of the first coupling rope body 23 and the first diamond knot 21. Moreover, compared with the first diamond knot 21 being directly coupled to the rope body 11, the coupling between the first coupling rope body 23 and the rope body 11 is easier, thus the difficulty of making the tow rope 100 is reduced.

In some embodiments, as illustrated in FIGS. 1 and 2, the first coupling end 232 of the first coupling rope body 23 is spliced to the rope body 11, that is, the first coupling rope body 23 is integrally formed with the rope body 11, so that the coupling between the first coupling rope body 23 and the rope body 11 is more reliable, at the same time, the integrity of the tow rope 100 is stronger and the use is more reliable.

In some embodiments, as illustrated in FIGS. 1 and 2, the first diamond knot 21 is integrally formed with the first coupling rope body 23. For example, the first free end 231 of the first coupling rope body 23 forms the first diamond knot 21 by means of knotting. The first diamond knot 21 is integrally formed with the first coupling rope body 23, so that the integrity of the tow rope 100 is stronger, and the reliability of use is higher.

In some embodiments, as illustrated in FIGS. 1 and 2, the length of the first coupling rope body 23 is less than a length of a rope body segment between the first coupling end 232 and the first loop 111. In some embodiments, the length of the rope body segment between the first coupling end 232 and the first loop 111 is 1.5-3 times the length of the first coupling rope body 23. A length between the first coupling end 232 and the second end of the rope body 23 is 10-50 times the length of the rope body segment between the first coupling end 232 and the first loop 111.

It could be understood that the length of the first coupling rope body 23 may also be equal to or greater than the length of the rope body segment between the first coupling end 232 and the first loop 111.

In some embodiments, as illustrated in FIGS. 1 and 2, the tow rope 100 may further include a first coupling fastening sleeve 24 and a first fastening sleeve 25, and the first coupling fastening sleeve 24 is sleeved on a junction of the first coupling rope body 23 and the rope body 11, which is configured to fasten and strengthen the coupling strength of the first coupling rope body 23 and the rope body 11, to avoid the first coupling rope body 23 being separated or decoupled from the rope body 11. The first fastening sleeve 25 is sleeved on a root of the first loop 111, which is configured to fasten and strengthen the strength of the root of the first loop 111, to prevent the root of the first loop 111 from being torn or separated by an external force.

As an example, as illustrated in FIGS. 1 and 2, the first coupling fastening sleeve 24 and the first fastening sleeve 25 are formed by winding a binding wire. The binding wire of the first coupling fastening sleeve 24 is wound on the junction of the first coupling rope body 23 and the rope body 11, and the binding wire of the first fastening sleeve 25 is wound on the root of the first loop 111.

In another example, the first coupling fastening sleeve 24 and the first fastening sleeve 25 may be a sleeve made of other materials, such as a rubber sleeve, a metal sleeve, etc.

In some embodiments, as illustrated in FIG. 1, a direction of the first coupling rope body 23 is the same as a direction of the first end of the rope body 11. In other words, the first coupling rope body 23 naturally extends from its first coupling end 232 towards the first loop 111, the tow rope 100 is stretched after the first diamond knot 21 is fastened to the first loop 111, and the first coupling rope body 23 is taut.

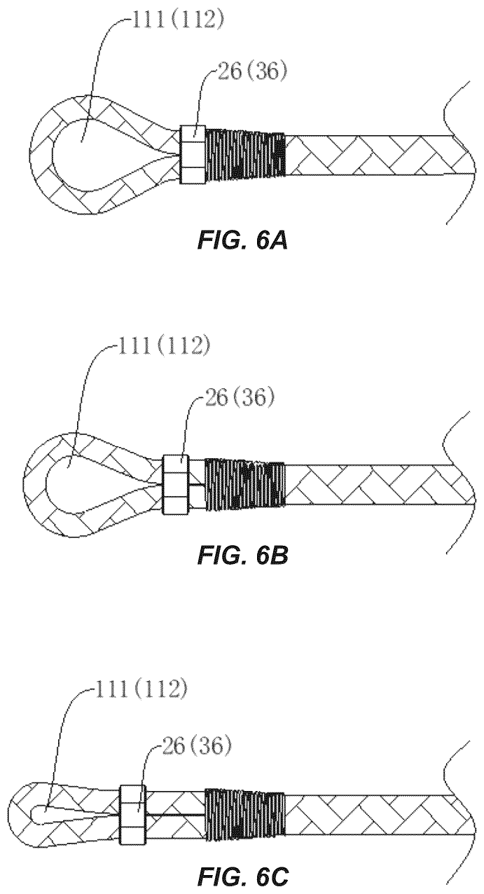

In some embodiments, as illustrated in FIGS. 1 and 6, the tow rope 100 further includes a first limiting sleeve 26, the first limiting sleeve 26 is sleeved on the root of the first loop 111, and the first limiting sleeve 26 is located between the first fastening sleeve 25 and the first loop 11. The first limiting sleeve 26 is movable along a length direction of the rope body 11 to change a size of the first loop 111. When the first limiting sleeve 26 moves towards the first loop 111, the first loop 111 becomes smaller; and when the first limiting sleeve 26 moves away from the first loop 111, the first loop 111 may become larger.

FIGS. 6A-6C show a process that the first limiting sleeve 26 gradually moves towards the first loop 111, and the first loop 111 gradually becomes smaller.

After the first loop 111 and the first diamond knot 21 are fastened, the first limiting sleeve 26 moves towards the first loop 111 to reduce the first loop 111, so that the first diamond knot 21 may be better stuck, preventing the first diamond knot 21 from being detached from the first loop 111, thus the fastening of the first loop 111 and the first diamond knot 21 is more reliable. After completion of use of the tow rope 100, the first limiting sleeve 26 is moved away from the first loop 111 to enlarge the first loop 111, so that the first diamond knot 21 is detached from the first loop 111. As illustrated in FIG. 6A, the size of the first loop 111 is the largest. As illustrated in FIG. 6C, the size of the first loop 111 is the smallest.

The first limiting sleeve 26 effectively avoids a deviation and loose rebound condition that may occur during a use process, reduces the possibility of the resulting personal safety problem or property loss, and ensures the safety and stability of the tow rope 100 during the use process.

In some examples, the first limiting sleeve 26 is a rubber sleeve. Accordingly, the first limiting sleeve 26 may be reliably sleeved on the rope body 11 through the deformation of the first limiting sleeve 26, avoiding loosening of the first limiting sleeve 26.

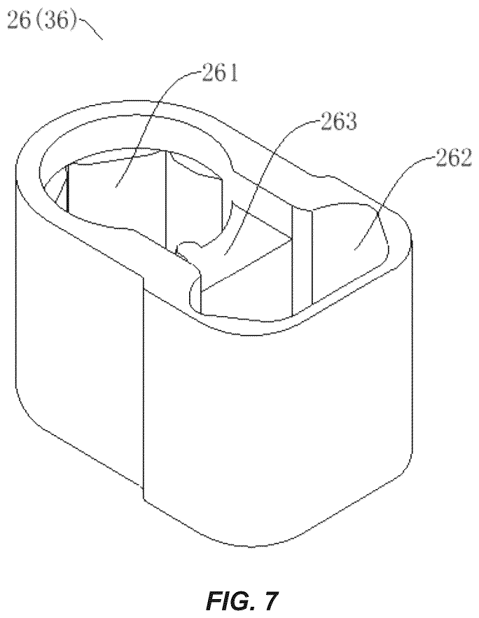

As an example, as illustrated in FIGS. 7 to 11, the first limiting sleeve 26 has a first through hole 261 and a second through hole 262 side by side, and an isolation part 263 is arranged in the first limiting sleeve 26 for isolating the first through hole 261 and the second through hole 262. An end face of the isolation part 263 away from the first loop 111 is flush with an end face of the first limiting sleeve 26 away from the first loop 111, and an end face of the isolation part 263 close to the first loop 111 is lower than an end face of the first limiting sleeve 26 close to the first loop 111.

The first limiting sleeve 26 is arranged at the root of the first loop 111, that is, a bifurcation of the first end of the rope body 11. Two strands of rope body segments for forming the first loop 111 that are split from the rope body 11 pass through the first through hole 261 and the second through hole 262, respectively, and the isolation part 263 is located between two rope strands.

As illustrated in FIGS. 7 to 11, the first through hole 261 is generally a circular hole, and its inner wall surface is provided with a plurality of protrusions that increase frictional force; and the second through hole 262 is a flat hole, and a width of the second through hole 262 is smaller than a diameter of the first through hole 261. Accordingly, the second through hole 262 may clamp the rope body tightly, increase the frictional force between the first limiting sleeve 26 and the rope body, and avoid loosening of the first limiting sleeve 26.

In some examples, the first through hole 261 of the first limiting sleeve 26 may be a flat hole similar to the second through hole 262, or the second through hole 262 may be a circular hole similar to the first through hole 261. In other examples, the first limiting sleeve 26 may have one through hole which is directly sleeved on the root of the first loop 111.

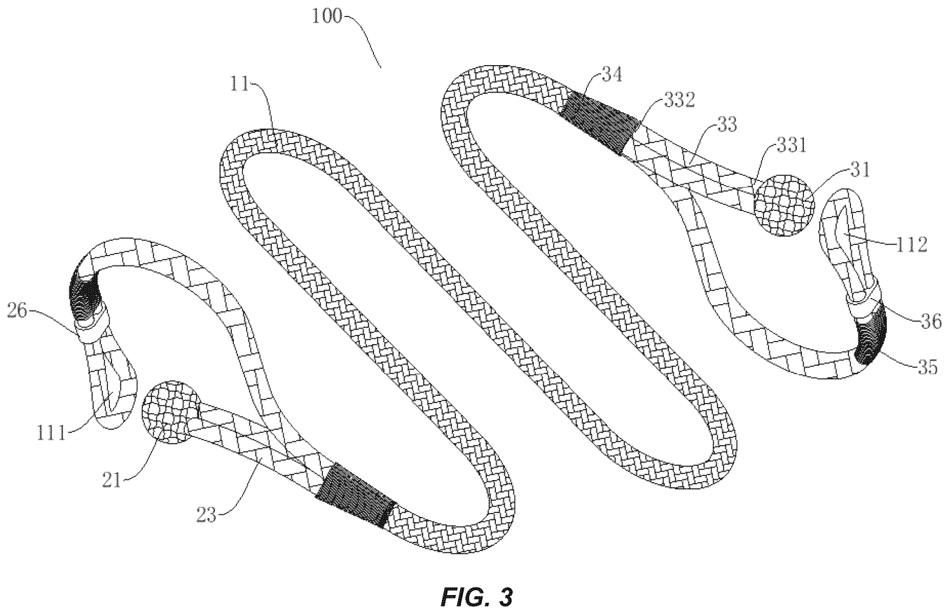

A tow rope 100 according to some embodiments of the present technology is described below with reference to FIGS. 3 to 5.

As illustrated in FIGS. 3 to 5, compared with embodiments illustrated in FIGS. 1 and 2, in the present embodiment, the tow rope 100 further includes a second diamond knot 31, the second end of the rope body 11 is provided with a second loop 112, the second diamond knot 31 is coupled to the rope body 11, and a coupling position of the second diamond knot 31 and the rope body 11 is adjacent to the second loop 112.

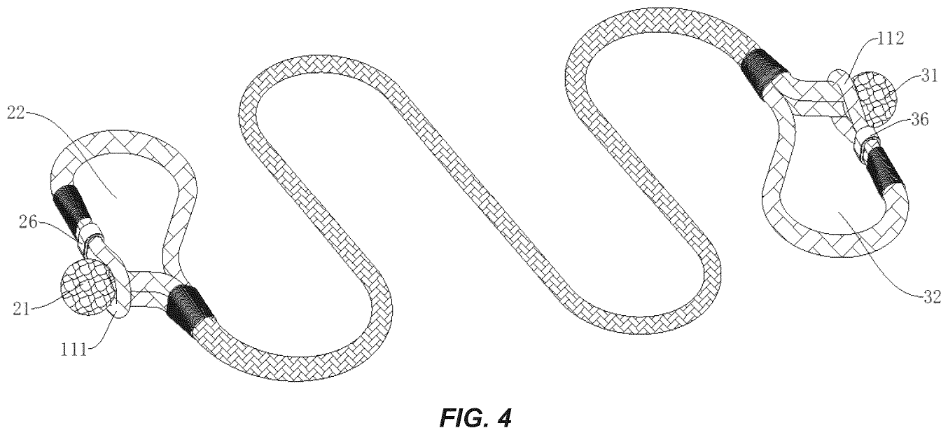

As illustrated in FIG. 4, the second diamond knot 31 and the second loop 112 are fastenable to form a second eye 32, and the second eye 32 may be sleeved on a coupling object.

As illustrated in FIG. 3, the second diamond knot 31 is detachable from the first loop 112, that is, the second diamond knot 31 comes out through the second loop 112 and is detached, and at this time, the second eye 32 is not formed at the second end of the rope body 11.

In example embodiments where the second diamond knot 31 is coupled to the rope body 11, this can include the second diamond knot 31 being directly arranged on the rope body 11, and the second diamond knot 31 being coupled to the rope body 11 through a certain length of coupling rope body. In embodiments illustrated in FIGS. 3 and 4, the second diamond knot 31 is coupled to the rope body 11 through a second coupling rope body 33.

For example, with respect to some embodiments, the meaning of “the coupling position of the second diamond knot 31 and the rope body 11 is adjacent to the second loop 112” is similar to that of “the coupling position of the first diamond knot 21 and the rope body 11 is adjacent to the first loop 111” in the above embodiments, which is not repeated herein.

When in use, for example, the second diamond knot and the second loop may be fastened around the coupling object such as the fixed pile, to form the second eye surrounding the fixed coupling object, so that it is convenient to couple the second end of the rope body to the coupling object. After use, for example, the second diamond knot is detached from the second loop, so that the second end of the rope body is detached from the coupling object, which further improves the convenience of coupling and decoupling the tow rope with the coupling object. The convenience of fastening and detachment operation between the second diamond knot and the second loop is not affected by the length of the rope body, and the length of the tow rope will not be shortened by the formation of the second eye, which further improves the use convenience of the tow rope.

In addition, the tow rope according to the embodiment has strong universality and convenience of use, and when in use, it may be directly sleeved on the tow hook or the shackle of the vehicle or the watercraft through the second loop, and may also be coupled to the coupling object such as the tree or the fixed pile by forming the second eye.

In some embodiments, the second loop 112 is formed by splicing the second end of the rope body 11, which is similar to “the first eye 111 is formed by splicing the first end of the rope body 11” in the above embodiments, and will not be repeated herein.

In some embodiments, the second diamond knot 31 is directly coupled to the rope body 11.

In some embodiments, the second diamond knot 31 is spliced to the rope body 11, so that the second diamond knot 31 is integrally formed with the rope body 11 and the coupling between them is more firm and reliable.

In some other embodiments, the tow rope 100 further includes the second coupling rope body 33, the second coupling rope body 33 has a second free end 331 and a second coupling end 332, the second diamond knot 31 is arranged at the second free end 331, and the second coupling end 332 is coupled to the rope body 11. The function of the second coupling rope body 33 is similar to that of the first coupling rope body 23 in the above embodiments.

In some embodiments, as illustrated in FIGS. 3 and 4, the second coupling end 332 of the second coupling rope body 33 is spliced to the rope body 11, that is, the second coupling rope body 33 is integrally formed with the rope body 11, so that the coupling between the second coupling rope body 33 and the rope body 11 is more reliable, at the same time, the integrity of the tow rope 100 is stronger.

In some embodiments, as illustrated in FIGS. 3 and 4, the second diamond knot 31 is integrally formed with the second coupling rope body 33. For example, the second free end 331 of the second coupling rope body 33 forms the second diamond knot 31 by means of knotting, so that the integrity of the tow rope 100 is stronger, and the reliability of use is higher.

In some embodiments, as illustrated in FIGS. 3 and 4, a length of the second coupling rope body 33 is less than a length of a rope body segment between the second coupling end 332 and the second loop 112. In some embodiments, the length of the rope body segment between the second coupling end 332 and the second loop 112 is 1.5-3 times the length of the second coupling rope body 33, and a length between the second coupling end 332 and the first end of the rope body 11 is 5-50 times the length of the rope body segment between the second coupling end 332 and the second loop 112.

The length of the second coupling rope body 33 may also be equal to or greater than the length of the rope body segment between the second coupling end 332 and the second loop 112.

In some embodiments, as illustrated in FIGS. 3 and 4, the tow rope 100 further includes a second coupling fastening sleeve 34 and a second fastening sleeve 35, and the second coupling fastening sleeve 34 is sleeved on a junction of the second coupling rope body 33 and the rope body 11, which is configured to fasten and strengthen the coupling strength of the second coupling rope body 33 and the rope body 11, to avoid the second coupling rope body 33 being separated or decoupled from the rope body 11. The second fastening sleeve 35 is sleeved on a root of the second loop 112, which is configured to fasten and strengthen the strength of the root of the second loop 112, to prevent the root of the second loop 112 from being torn or separated by an external force.

As an example, as illustrated in FIGS. 3 to 5, the second coupling fastening sleeve 34 and the second fastening sleeve 35 are both formed by winding the binding wire. A structure of the second coupling fastening sleeve 34 is similar to that of the first coupling fastening sleeve 24 in the above embodiments, and a structure of the second fastening sleeve 35 is similar to that of the first fastening sleeve 25 in the above embodiments.

In some embodiments, as illustrated in FIGS. 3 to 11, the tow rope 100 further includes a second limiting sleeve 36, and the second limiting sleeve 36 is sleeved on the root of the second loop 112 and is movable along the length direction of the rope body 11 to change the size of the second loop 112. When the second limiting sleeve 36 moves towards the second loop 112, the first loop 112 becomes smaller; and when the second limiting sleeve 36 moves away from the second loop 112, the second loop 112 becomes larger. The second limiting sleeve 36 is similar to the first limiting sleeve 26 in the above embodiments, and it is not repeated herein.

In some embodiments, as illustrated in FIGS. 3 to 5, the tow rope 100 is centrally symmetrical. The first loop 111 at the first end of the rope body 11 is symmetrical in structure with the second loop 112 at the second end of the rope body 11, the length of the first coupling rope body 23 is equal to the length of the second coupling rope body 33, and a distance between the coupling position of the first coupling rope body 23 and the rope body 11 and the first end of the rope body 11 is equal to a distance between a coupling position of the second coupling rope body 33 and the rope body 11 and the second end of the rope body 11.

Embodiments of the present technology further provide a winch, including a reel and a tow rope, the tow rope may be a tow rope 100 in the above embodiments, and the tow rope 100 is wound around the reel.

As mentioned above, the first end of the rope body 11 may be provided with the first loop 111, and the first diamond knot 21 coupled to the rope body 11 is arranged adjacent to the first loop 111. Thus, the first end of the tow rope 100 may be sleeved on an equipment to be towed (e.g., the vehicle or the watercraft to be towed) or a fixed object (e.g., the tree or the fixed pile).

The second end of the tow rope 100 may be provided with the second loop and the second diamond knot coupled to the rope body is arranged adjacent to the second loop, and alternatively the tow rope may also be provided without the second loop and the second diamond knot.

A tow rope according to some example embodiments of the present technology includes a rope body and a first diamond knot. The rope body has a first end and a second end, and the first end of the rope body is provided with a first loop. The first diamond knot is coupled to the rope body, and a coupling position of the first diamond knot and the rope body is adjacent to the first loop. The first diamond knot and the first loop are fastenable to form a first eye, and the first diamond knot is detachable from the first loop.

In some embodiments, the first loop is formed by splicing the first end of the rope body.

In some embodiments, the tow rope further includes a first coupling rope body, the first coupling rope body has a first free end and a first coupling end, the first diamond knot is arranged at the first free end, and the first coupling end is coupled to the rope body.

In some embodiments, the first coupling end is spliced to the rope body.

In some embodiments, the first diamond knot is integrally formed with the first coupling rope body.

In some embodiments, a length of the first coupling rope body is less than a length of a rope body segment between the first coupling end and the first loop.

In some embodiments, the tow rope further includes a first fastening sleeve and a first coupling fastening sleeve, the first coupling fastening sleeve is sleeved on a junction of the first coupling rope body and the rope body, and the first fastening sleeve is sleeved on a root of the first loop.

In some embodiments, the first coupling fastening sleeve and the first fastening sleeve are formed by winding a binding wire.

In some embodiments, the tow rope further includes a first limiting sleeve, and the first limiting sleeve is sleeved on the root of the first loop and is movable along a length direction of the rope body to change a size of the first loop.

In some embodiments, the tow rope further includes a second diamond knot, the second end of the rope body is provided with a second loop, the second diamond knot is coupled to the rope body, a coupling position of the second diamond knot and the rope body is adjacent to the second loop, the second diamond knot and the second loop are fastenable to form a second eye, and the second diamond knot is detachable from the second loop.

In some embodiments, the second loop is formed by splicing the second end of the rope body.

In some embodiments, the tow rope further includes a second coupling rope body, the second coupling rope body has a second free end and a second coupling end, the second diamond knot is arranged at the second free end, and the second coupling end is coupled to the rope body.

In some embodiments, the second coupling end is spliced to the rope body.

In some embodiments, the second diamond knot is integrally formed with the second coupling rope body.

In some embodiments, a length of the second coupling rope body is less than a length of a rope body segment between the second coupling end and the second loop.

In some embodiments, the tow rope further includes a second coupling fastening sleeve and a second fastening sleeve, the second coupling fastening sleeve is sleeved on a junction of the second coupling rope body and the rope body, and the second fastening sleeve is sleeved on a root of the second loop.

In some embodiments, the second coupling fastening sleeve and the second fastening sleeve are formed by winding the binding wire.

In some embodiments, the tow rope further includes a second limiting sleeve, and the second limiting sleeve is sleeved on the root of the second loop and is movable along the length direction of the rope body to change a size of the second loop.

In some embodiments, the tow rope is centrally symmetrical.

### EXAMPLES

In some embodiments in accordance with the present technology (example 1), a tow rope comprises a rope body having a first end and a second end, the first end of the rope body comprising a first loop; and a first diamond knot coupled to the rope body, a coupling position of the first diamond knot and the rope body being adjacent to the first loop, wherein the first diamond knot and the first loop are fastenable to form a first eye, and the first diamond knot is detachable from the first loop.

Example 2 includes the tow rope of example 1 or any of examples 1-19, wherein the first loop is formed by splicing the first end of the rope body.

Example 3 includes the tow rope of example 1 or any of examples 1-19, further comprising a first coupling rope body having a first free end and a first coupling end, wherein the first coupling end is coupled to the rope body, and wherein the first diamond knot is arranged at the first free end.

Example 4 includes the tow rope of example 3 or any of examples 1-19, wherein the first coupling end is spliced to the rope body.

Example 5 includes the tow rope of example 3 or any of examples 1-19, wherein the first diamond knot is integrally formed with the first coupling rope body.

Example 6 includes the tow rope of example 3 or any of examples 1-19, wherein a length of the first coupling rope body is less than a length of a rope body segment between the first coupling end and the first loop.

Example 7 includes the tow rope of example 3 or any of examples 1-19, further comprising a first fastening sleeve; and a first coupling fastening sleeve, wherein the first coupling fastening sleeve is sleeved on a junction of the first coupling rope body and the rope body, and wherein the first fastening sleeve is sleeved on a root of the first loop.

Example 8 includes the tow rope of example 7 or any of examples 1-19, wherein the first coupling fastening sleeve and the first fastening sleeve are formed by winding a binding wire.

Example 9 includes the tow rope of example 1 or any of examples 1-19, further comprising a first limiting sleeve, wherein the first limiting sleeve is sleeved on a root of the first loop and is movable along a length direction of the rope body to change a size of the first loop.

Example 10 includes the tow rope of example 1 or any of examples 1-19, further comprising a second diamond knot coupled to the rope body, a coupling position of the second diamond knot and the rope body being adjacent to the second loop, wherein the second end of the rope body is provided with a second loop, wherein the second diamond knot and the second loop are fastenable to form a second eye, and the second diamond knot is detachable from the second loop.

Example 11 includes the tow rope of example 10 or any of examples 1-19, wherein the second loop is formed by splicing the second end of the rope body.

Example 12 includes the tow rope of example 10 or any of examples 1-19, further comprising a second coupling rope body having a second free end and a second coupling end, wherein the second coupling end is coupled to the rope body, and wherein the second diamond knot is arranged at the second free end.

Example 13 includes the tow rope of example 12 or any of examples 1-19, wherein the second coupling end is spliced to the rope body.

Example 14 includes the tow rope of example 12 or any of examples 1-19, wherein the second diamond knot is integrally formed with the second coupling rope body.

Example 15 includes the tow rope of example 12 or any of examples 1-19, wherein a length of the second coupling rope body is less than a length of a rope body segment between the second coupling end and the second loop.

Example 16 includes the tow rope of example 12 or any of examples 1-19, further comprising a second coupling fastening sleeve; and a second fastening sleeve, wherein the second coupling fastening sleeve is sleeved on a junction of the second coupling rope body and the rope body, and wherein the second fastening sleeve is sleeved on a root of the second loop.

Example 17 includes the tow rope of example 16 or any of examples 1-19, wherein the second coupling fastening sleeve and the second fastening sleeve are formed by winding a binding wire.

Example 18 includes the tow rope of example 10 or any of examples 1-19, further comprising a second limiting sleeve, wherein the second limiting sleeve is sleeved on a root of the second loop and is movable along a length direction of the rope body to change a size of the second loop.

Example 19 includes the tow rope of example 10 or any of examples 1-18, wherein the tow rope is centrally symmetrical.

In some embodiments in accordance with the present technology (example 20), a winch comprises a reel; and a tow rope, which the tow rope comprises a rope body having a first end and a second end, the first end of the rope body being provided with a first loop; and a first diamond knot coupled to the rope body, a coupling position of the first diamond knot and the rope body being adjacent to the first loop, wherein the first diamond knot and the first loop are fastenable to form a first eye, and the first diamond knot is detachable from the first loop, and wherein the tow rope is wound around the reel.

### Conclusion

In the description of the present technology, it should be understood that the orientation or position relationship indicated by the terms “center,” “longitudinal,” “transverse,” “length,” “width,” “thickness,” “up,” “down,” “front,” “rear,” “left,” “right,” “vertical,” “horizontal,” “top,” “bottom,” “inner,” “outer,” “clockwise,” “counterclockwise,” “axial,” “radial” and “circumferential” and the like, is based on the orientation or position relationship illustrated in the accompanying drawings, which is only for the convenience of describing the present technology and simplifying the description, and does not indicate or imply that the referred device or element must have a specific orientation, and be constructed and operated in a specific orientation, so it cannot be understood as a limitation of the present technology.

In addition, the terms “first” and “second” are only used for purpose of description, and cannot be understood as indicating or implying relative importance or implicitly indicating the number of indicated technical features. Therefore, the feature defined as “first” or “second” may explicitly or implicitly include at least one such feature. In the description of the present technology, the term “a plurality of” means at least two, such as two, three, etc., unless otherwise specifically defined.

In the present disclosure, unless otherwise expressly defined, terms such as “install/mount,” “interconnect,” “couple,” “fix” shall be understood broadly, and may be, for example, fixed connections, detachable connections, or integral connections; may also be mechanical or electrical connections or intercommunication; may also be direct connections or indirect connections via intervening media; may also be inner communications or interactions of two elements, unless otherwise specifically defined. For those skilled in the art, the specific meaning of the above terms in the present disclosure may be understood according to the specific situations.

In the present disclosure, unless otherwise expressly defined and specified, a structure in which a first feature is “on” or “below” a second feature may include some embodiments in which the first feature is in direct contact with the second feature, or may further include some embodiments in which the first feature and the second feature are in indirect contact through intermediate media. Furthermore, a first feature “on,” “above,” or “on top of” a second feature may include some embodiments in which the first feature is right or obliquely “on,” “above,” or “on top of” the second feature, or just means that the first feature is at a height higher than that of the second feature. A first feature “below,” “under,” or “on bottom of” a second feature may include some embodiments in which the first feature is right or obliquely “below,” “under,” or “on bottom of” the second feature, or just means that the first feature is at a height lower than that of the second feature.

In the description of the present disclosure, terms such as “an embodiment,” “some embodiments,” “an example,” “a specific example” or “some examples” means that a particular feature, structure, material, or characteristic described in junction with the embodiment or example is included in at least one embodiment or example of the present technology. Thus, the appearances of these terms in various places throughout this specification are not necessarily referring to the same embodiment or example of the present technology. Furthermore, the particular features, structures, materials, or characteristics may be combined in any suitable manner in one or more embodiments or examples. In addition, without contradiction, those skilled in the art may combine and unite different embodiments or examples or features of the different embodiments or examples described in this specification. Although the embodiments of the present technology have been illustrated and described above, it may be understood that the above embodiments are illustrative and shall not be understood as limitation to the present technology, and changes, modifications, alternatives and variations may be made in the above embodiments within the scope of the present technology by those skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A tow rope, comprising:
a rope body having a first end and a second end, the first end of the rope body comprising a first loop; and
a first diamond knot coupled to the rope body, a coupling position of the first diamond knot and the rope body being adjacent to the first loop,
wherein the first diamond knot and the first loop are fastenable to form a first eye, and the first diamond knot is detachable from the first loop.

2. The tow rope according to claim 1, wherein the first loop is formed by splicing the first end of the rope body.

3. The tow rope according to claim 1, further comprising:
a first coupling rope body having a first free end and a first coupling end, wherein the first coupling end is coupled to the rope body, and wherein the first diamond knot is arranged at the first free end.

4. The tow rope according to claim 3, wherein the first coupling end is spliced to the rope body.

5. The tow rope according to claim 3, wherein the first diamond knot is integrally formed with the first coupling rope body.

6. The tow rope according to claim 3, wherein a length of the first coupling rope body is less than a length of a rope body segment between the first coupling end and the first loop.

7. The tow rope according to claim 3, further comprising:
a first fastening sleeve; and
a first coupling fastening sleeve,
wherein the first coupling fastening sleeve is sleeved on a junction of the first coupling rope body and the rope body, and wherein the first fastening sleeve is sleeved on a root of the first loop.

8. The tow rope according to claim 7, wherein the first coupling fastening sleeve and the first fastening sleeve are formed by winding a binding wire.

9. The tow rope according to claim 1, further comprising:
a first limiting sleeve, wherein the first limiting sleeve is sleeved on a root of the first loop and is movable along a length direction of the rope body to change a size of the first loop.

10. The tow rope according to claim 1, further comprising:
a second diamond knot coupled to the rope body, a coupling position of the second diamond knot and the rope body being adjacent to the second loop,
wherein the second end of the rope body is provided with a second loop,
wherein the second diamond knot and the second loop are fastenable to form a second eye, and the second diamond knot is detachable from the second loop.

11. The tow rope according to claim 10, wherein the second loop is formed by splicing the second end of the rope body.

12. The tow rope according to claim 10, further comprising:
a second coupling rope body having a second free end and a second coupling end, wherein the second coupling end is coupled to the rope body, and wherein the second diamond knot is arranged at the second free end.

13. The tow rope according to claim 12, wherein the second coupling end is spliced to the rope body.

14. The tow rope according to claim 12, wherein the second diamond knot is integrally formed with the second coupling rope body.

15. The tow rope according to claim 12, wherein a length of the second coupling rope body is less than a length of a rope body segment between the second coupling end and the second loop.

16. The tow rope according to claim 12, further comprising:
a second coupling fastening sleeve; and
a second fastening sleeve,
wherein the second coupling fastening sleeve is sleeved on a junction of the second coupling rope body and the rope body, and wherein the second fastening sleeve is sleeved on a root of the second loop.

17. The tow rope according to claim 16, wherein the second coupling fastening sleeve and the second fastening sleeve are formed by winding a binding wire.

18. The tow rope according to claim 10, further comprising:
a second limiting sleeve, wherein the second limiting sleeve is sleeved on a root of the second loop and is movable along a length direction of the rope body to change a size of the second loop.

19. The tow rope according to claim 10, wherein the tow rope is centrally symmetrical.

20. A winch, comprising:
a reel; and
a tow rope, comprising:
a rope body having a first end and a second end, the first end of the rope body being provided with a first loop; and
a first diamond knot coupled to the rope body, a coupling position of the first diamond knot and the rope body being adjacent to the first loop,
wherein the first diamond knot and the first loop are fastenable to form a first eye, and the first diamond knot is detachable from the first loop, and
wherein the tow rope is wound around the reel.
